(19) United States
(12) Patent Application Publication
(10) Pub. No.: US 2008/0089735 A1
(43) Pub. Date: Apr. 17, 2008

(54) Cover for the head of a foaming brush

(75) Inventors: Robert D. Black, Morrison, IL (US); Maureen Lefebure, Camanche, IA (US)

Correspondence Address: ICE MILLER LLP, ONE AMERICAN SQUARE, SUITE 3100, INDIANAPOLIS, IN, 46282-0200, US

(73) Assignee: Super Wash, Inc.

(21) Appl. No.: 11/974,996

(22) Filed: Oct. 17, 2007

Related U.S. Application Data
(60) Provisional application No. 60/829,762, filed on Oct. 17, 2006.

(51) Int. Cl. A47L 13/22; A46B 17/04; B43K 8/00

(52) U.S. Cl. 401/289; 401/202; 15/247; 401/269; 401/196

(57) ABSTRACT

A cover for the head of a foam brush of the type that expels foam from the head thereof includes a bag and a closure device. The bag has a continuous scrubbing surface and a side wall joined together to form an interior cavity, The bag has a mouth for allowing ingress into the interior cavity and has a plurality of foam discharge holes in side wall thereof for allowing foam to pass therethrough. The closure device is configured to close the mouth of the bag when the head of a brush is received in the interior cavity and to removably secure the bag to the head of the brush.

### RELATED APPLICATIONS

This application claims priority to co-pending provisional application Ser. No. 60/829,762 filed Oct. 17, 2006, the disclosure of which is incorporated herein by this reference.

### FIELD

This application relates to water permeable brush head covers and more particularly to brush head covers for foaming brushes utilized in self serve car wash facilities.

### BACKGROUND AND SUMMARY

Car wash facilities and in particular coin operated self serve car wash bays include a source of water, a source of chemicals, such as, for example, soap detergent, wax, polish, etc., a switch to select dispensing of water or soap or combinations thereof, a flexible hose leading from the sources to one end of a hollow wand or handle with an aperture or nozzle at its opposite end. The customer deposits the required coinage, and directs the selected water or soap flowing from the source through the hose and outward from the aperture or nozzle and onto the various surfaces of the car. Typically the water and soap are delivered under pressure to facilitate cleaning and rinsing of the car surface without actual contact between the wand or handle and the car surface so as to prevent scratching or marring of the finish, paint or other surfaces of the car.

Most self operated car washes have installed brushes. These brushes are provided to allow frictional contact between them and the car surface allegedly to remove grime, tar and other foreign objects adhered to the car's surfaces. Typically, such brushes are attached to a source of compressed air that is dispensed through the head of the brush to provide foaming soapy water to the bristles or other scrubbing component of the brush. Various styles of foaming brushes are known, including, but not limited to foaming brushes having a head formed from a plurality of bristles held in a bristle support and foaming brushes having a rubber or sponge scrubbing element held in a scrubbing element support. In general, the term scrubbing element when used herein should be deemed to encompass the portion of a foaming brush intended to engage the surface of an item being washed and to apply frictional forces to the surface of the item being washed. Thus, unless otherwise indicated, a scrubbing element may include bristles, foam rubber elements, sponge elements, cloth strips and other items disposed in a foaming brush head and intended to engage the surface of the item being washed to facilitate loosening foreign objects from the item. To simplify the description of the foaming brush head cover disclosed herein, the cover will be described as being utilized with a brush having bristles with it being understood that such description applies equally well to a brush having some other scrubbing element.

One issue related to the use of friction brushes which has plagued the car wash industry since self-serve car washes initially offered a foaming brush service option is the potential danger of damage to washed items arising from a foreign object or other substance remaining on the brush head from a prior user. As indicated above, the foreign object or other substance on the brush head can potentially harm a vehicle's finish. For example, dirt, mud, grit, brake dust, sand, salt, engine degreaser, tar, engine oil, etc. can all adhere to or otherwise contaminate or damage the bristles on a foaming brush head. In addition, the prior user may have sought to clean off-road vehicles, boats on trailers, vehicle engines, or other transportable items, introducing possible contaminants onto the brush from sources not familiar to or typically encountered by the next user. Thus, the possibility exists that some harmful foreign matter will contaminate the bristles or scrubbing element of the foaming brush and/or degrade the brush itself, either or both of which may negatively impact the painted surfaces, finish or other surfaces of the customer's vehicle by marring or scratching. When foreign matter contaminates the bristles of a brush head, some level of damage (such as scratching) to a vehicle may easily result. Obviously, damage to a customer's vehicle could create a large liability and the potential for a very unsatisfied customer for the car wash owner.

Thus, owners and users of self service car wash bays, as well as their insurers, would appreciate users having access to a cover for a foaming brush head that would protect the finish of the vehicle being washed from possible damage resulting from foreign matter contamination of the brush. Users of a car wash facility would also appreciate having a cover that they could purchase at the wash and/or keep in their vehicle and used when needed and that would allow them to have the advantage of the friction created by brush use without having to worry about damage caused by foreign contaminants in the brush head causing damage to the vehicle or other object they are washing. For simplicity, and since it is preferred that the foaming brush be utilized to wash only vehicles, the object being cleaned with the foaming brush and the disclosed cover often will be referred to herein as a vehicle, it being understood that foaming brush users may utilize the foaming brush and the disclosed cover combination to wash other objects within the scope of the disclosure.

The disclosed cover for foaming brush heads is configured to provide a protective cover for a foaming brush head that reduces the likelihood that contaminants on the brush head will contact the finished surface of the item being washed while allowing foaming soap, detergent and/or water (hereinafter referred to as foaming cleaning liquid or foam) from the brush head to permeate the cover. The disclosed cover is intended to be used in conjunction with a car wash that offers a foaming brush option.

According to one aspect of the disclosure, a cover for a foaming brush having a head including a scrubbing member and a scrubbing support configured to allow foam to pass through the scrubbing member to a scrubbing surface of the brush having a footprint includes a flexible scrubbing panel, a flexible side wall and a closure device. The flexible scrubbing panel is configured to conform generally to the footprint of the scrubbing surface of the foaming brush and is formed from a solid sheet of material including an outwardly disposed surface having a continuous surface and texture that should not adversely affect a finished surface of an item being washed. The flexible side wall is contiguously joined at a bottom edge to a substantial portion of a peripheral edge of the scrubbing panel and cooperates with the scrubbing panel to define a substantial enclosure closed on the bottom by the scrubbing panel, substantially closed on the side by the side wall and including a top opening. The flexible side wall is configured to define one or more foam discharge holes through which foam from a foaming brush having its head disposed in an interior of the enclosure discharges to an exterior of the enclosure, permitting foam to surround the cover and flow around it when the cover is in contact with the car surface and release excess fluids within the cover and permitting the scrubbing panel to remain in close contact with the vehicle surface being cleaned. The closure device is coupled to the side wall adjacent the top opening and is configured to at least partially close the top opening when a head of a foaming brush is received in the interior of the enclosure to maintain the cover in place over the brush during the cleaning process and facilitating its removal at the end of the process.

According to another aspect of the disclosure, a cover for the head of a foam brush of the type that expels foam from the head thereof is provided that also includes a bag and a closure device. The bag has a scrubbing surface and a side wall joined together to form an interior cavity. The bag has a mouth for allowing ingress into the interior cavity and has a plurality of foam discharge holes in the side wall thereof for allowing foam to pass therethrough. The closure device is configured to close the mouth of the bag when the head of a brush is received in the interior cavity and to secure the bag to the head of the brush.

According to yet another aspect of the disclosure a combination includes a foam brush and a cover. The foam brush comprises a head and a handle. The head includes a scrubbing member having a scrubbing surface and a support for the scrubbing member. The handle is coupled to the head. The head is coupled through the handle to a soap/water source and configured to allow a soap/water mixture to expel foam from the scrubbing member. The cover covers the head of the foam brush and comprises a bag and a cord. The bag has a scrubbing surface and a side wall joined together to form an interior cavity holding the head of the foam brush with the scrubbing surface of the bag positioned adjacent the scrubbing surface of the brush to prevent any portion of the scrubbing surface of the brush from contacting an item being washed with the combination. The bag has a mouth through which the handle of the foam brush extends from the support of the head. The bag has a plurality of holes in the side wall thereof allowing foam from the head of the foam brush to pass therethrough. The bag is formed to include a channel adjacent the mouth. The cord extends through the channel adjacent the mouth of the bag and cooperates with the channel to form a drawstring type closure which upon pulling the cord draws the bag around the head of the foam brush and secures the bag to the head of the foam brush.

Additional features and advantages of the present disclosure will become apparent to those skilled in the art upon consideration of the following detailed description of a preferred embodiment exemplifying the best mode of carrying out the disclosure as presently perceived.

### BRIEF DESCRIPTION

The present disclosure is illustrated by way of example and not limitation in the figures of the accompanying drawings in which like references indicate similar elements and in which:

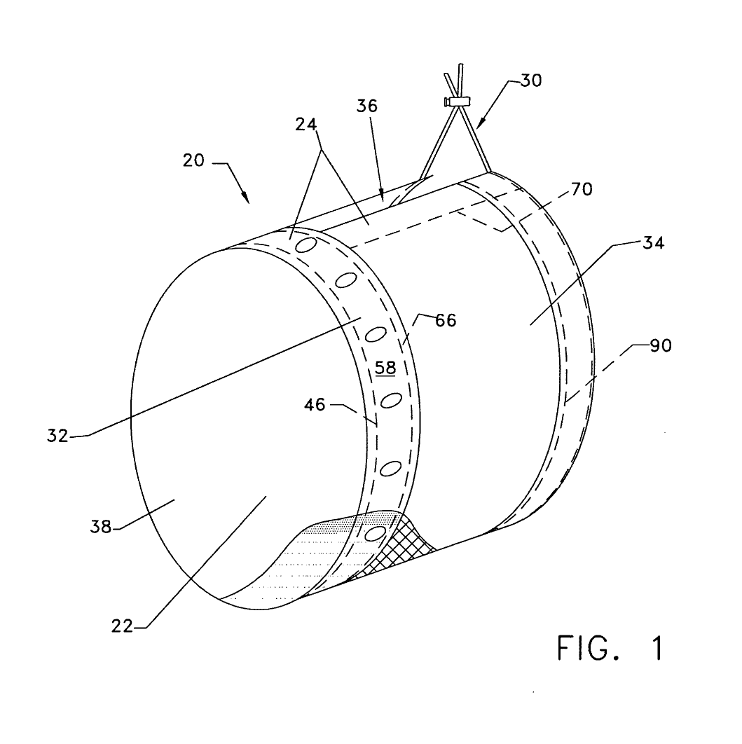

FIG. 1 is a perspective view of one embodiment of a foaming brush cover configured for utilization with a foaming brush having a generally cylindrically shaped brush head showing the cover having a scrubbing component, a side wall component and a drawstring closure wherein textural features of the material from which the various components are formed are shown only in small areas of the drawing to facilitate easier understanding of the manner in which the cover is assembled;

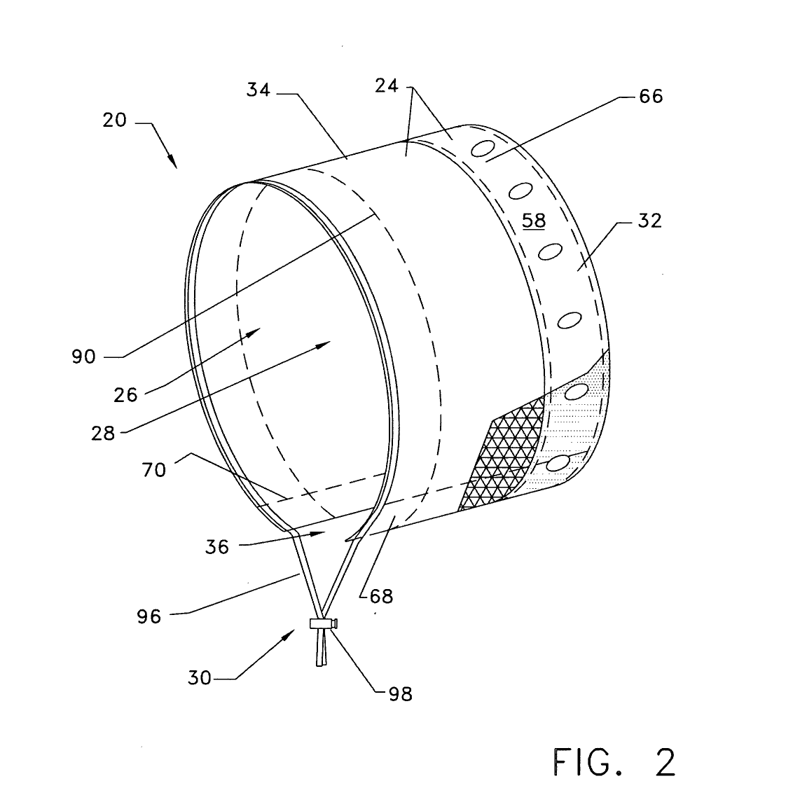

FIG. 2 is a perspective view from a different perspective of the foaming brush cover of FIG. 1 wherein textural features of the material from which the various components are formed are shown only in small areas of the drawing to facilitate easier understanding of the manner in which the cover is assembled;

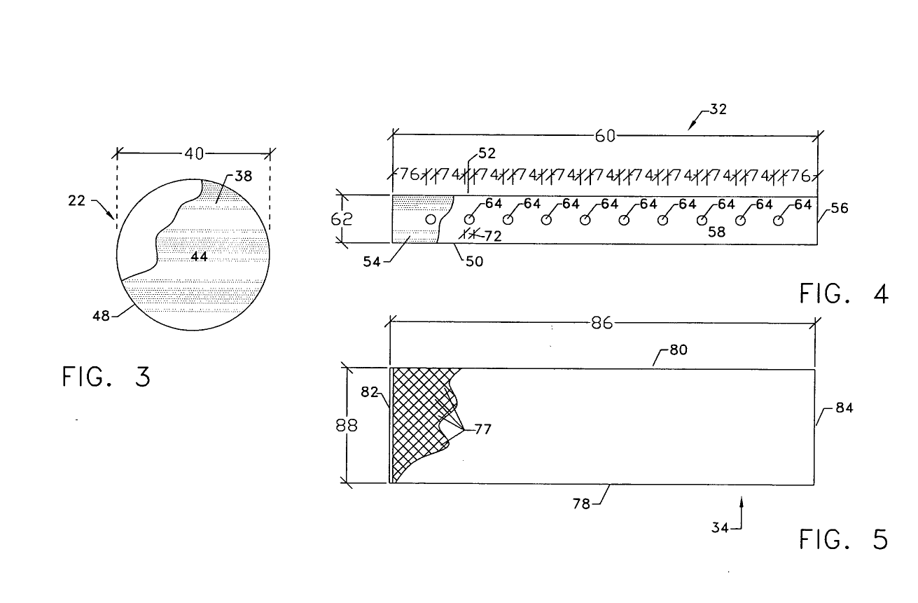

FIG. 3 is a plan view of the scrubbing component of the brush cover of FIG. 1 prior to being joined to the side wall component wherein textural features of the material from which the component is formed are shown only in a small area of the drawing;

FIG. 4 is plan view of a first component of the side wall of the brush cover of FIG. 1 prior to being joined to the scrubbing component and the second component of the side wall wherein textural features of the material from which the component is formed are shown only in a small area of the drawing;

FIG. 5 is a plan view of a second component of the side wall of the brush cover of FIG. 1 prior to being joined to the first component of the side wall and to itself to form a passage through which the drawstring is received wherein textural features of the material from which the component is formed are shown only in a small area of the drawing;

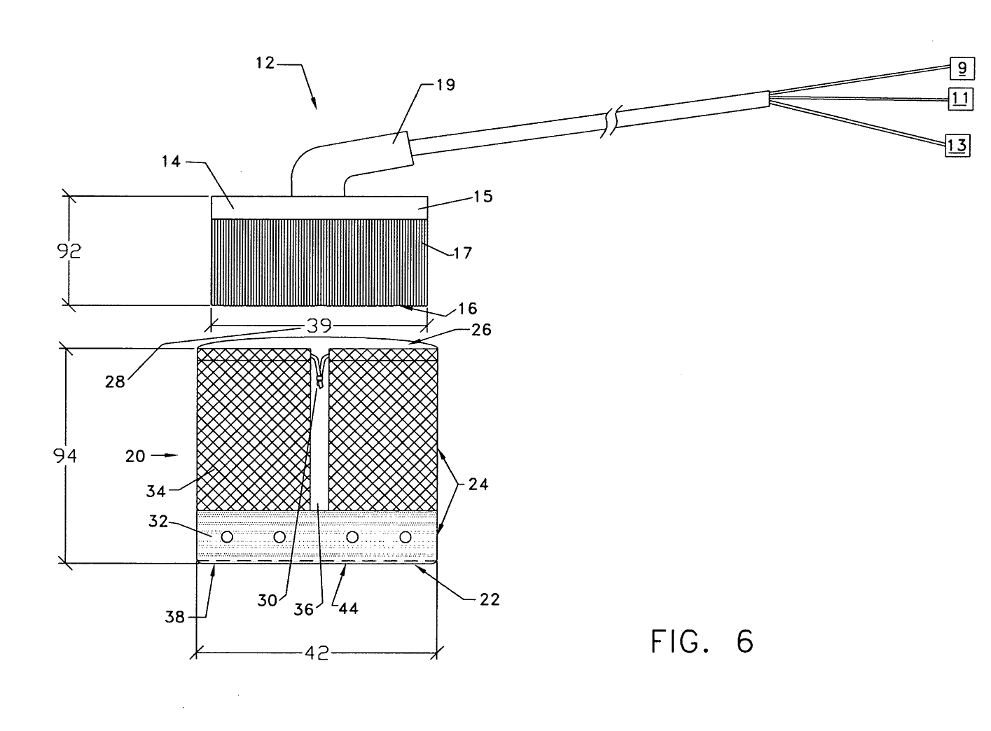

FIG. 6 is a side elevation view of the foaming brush cover of FIG. 1 prior to attachment to the head of a foaming brush coupled to a diagrammatically represented sources of water, detergent and compressed air;

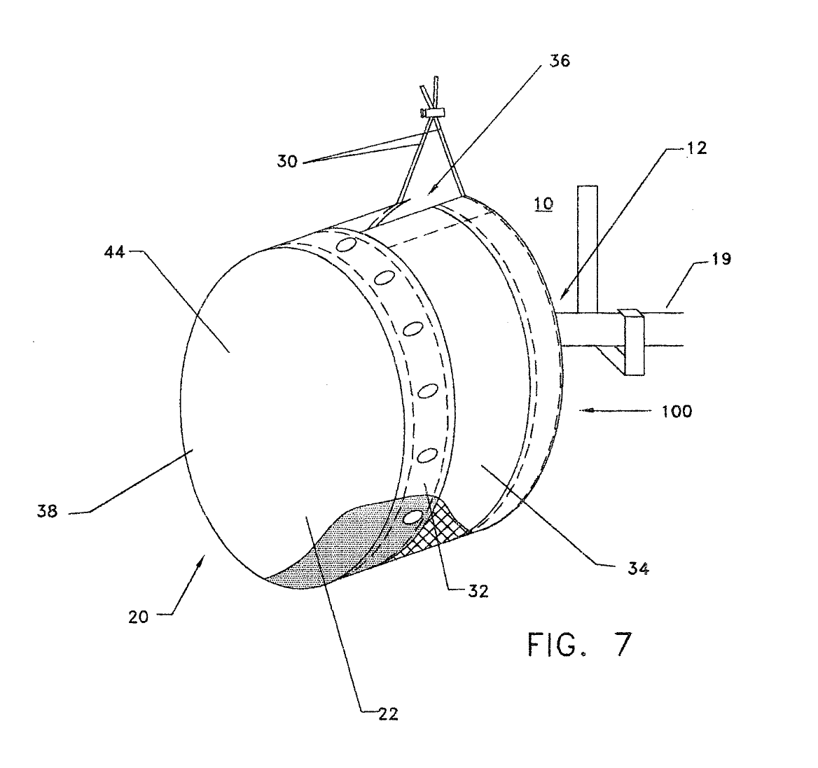

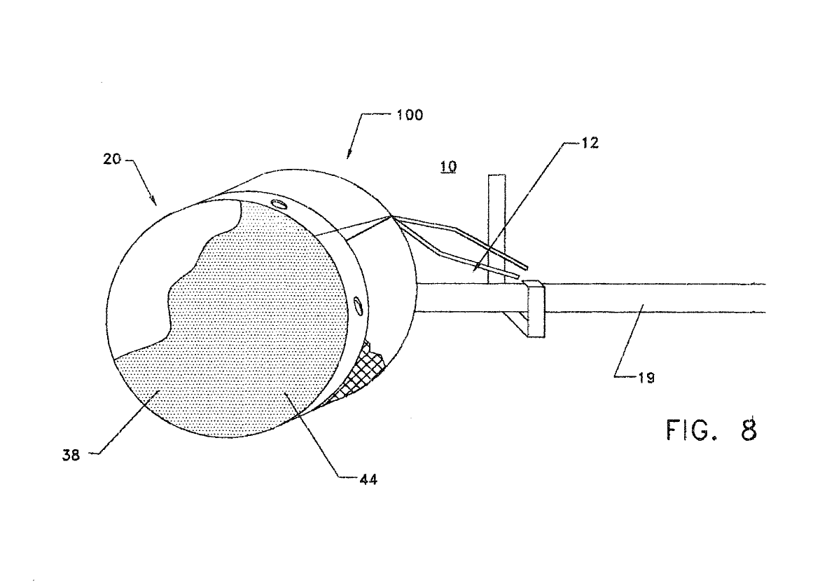

FIG. 7 is a perspective view of the foaming brush head cover during attachment to the head of the foaming brush of FIG. 6; and

FIG. 8 is a perspective view of the foaming brush head cover attached to the foaming brush of FIG. 7.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

As shown, for example, in FIGS. 1-8, a first embodiment of the disclosed brush head cover 20 is configured to be installed over the head 14 of a foaming brush 12 at a car wash 10. It is envisioned that a car wash patron may purchase a reusable or disposable brush cover 20 to use exclusively on their own vehicle, similar to the manner in which a car wash patron may purchase other items at the wash site from vending machines, or by purchase at automotive supply stores or departments or other retail outlets. By obtaining and using a protective cover 20 on the brush head 14 of a foaming brush 12, the customer's vehicle is protected from contaminates and foreign matter left on the brush head 14 from a prior user of the car wash 10. When a user utilizes the brush head cover 20 properly in conjunction with a foaming brush 12 the scrubbing panel 22 of the brush cover 20 comes in contact with the painted surface, rather than a potentially contaminated scrubbing surface 16 of the foaming brush head 14. The user of the car wash 10 can then realize the cleaning advantage of creating friction between the cover 20 attached to the brush 12 and the item being washed at any self serve car wash site, while at the same time protecting the item being washed from a potentially damaging contaminated brush head 14.

As shown, for example, in FIGS. 1, 2, 6-8 brush head cover, bonnet or cap 20 is configured for use with a foaming brush 12 having a head 14 formed from a disk-shaped bristle support 15 from which bristles 17 extend substantially perpendicular to a face of the support disk 15. A handle 19 is coupled to the head 14 of the brush 12 and to sources of water 9, soap or detergent 11 and compressed air 13, as shown, for example in FIG. 6. Thus, the brush head 14 with which the illustrated embodiment of the brush head cover 20 is intended to be used has a generally cylindrical shape. Consequently, the illustrated embodiment of the brush head cover 20 is shown in FIGS. 1, 2 and 6 as having a generally cylindrical shape. However, as will be described later, the brush head cover 20 is formed from flexible materials, the brush head cover 20 is not sufficiently rigid to maintain the cylindrical shape shown in FIGS. 1, 2 and 6 on its own, and can adapt to conform to oval, elliptical, hexagonal, rectangular, square and other shape brush supports and/or can be formed from geometries corresponding substantially to that of the brush support and brushes. Nevertheless, for ease of description, the brush head cover 20 will be described as being substantially cylindrical shaped, it being understood that such description encompasses such alternative configurations.

The brush head cover 20 includes a scrubbing panel 22 and a two-component side wall 24 that cooperate to form a substantially cylindrical substantial enclosure with a top opening 26 communicating with an interior cavity 28 and a closure device 30 for reducing the size of the top opening 26. The two-component side wall 24 includes a first panel 32 and a second panel 34. The term “substantial enclosure” was utilized above, because, as shown in FIGS. 1 and 2, the opposite ends of the panels 32, 34 forming the side wall 24 are not joined to each other and thus a gap 36 in the side wall 24 extends from the scrubbing panel 22 to the top opening 26. The term bag as used herein includes a substantial enclosure.

Because the illustrated brush head cover 20 is configured for use with a foaming brush 12 having a substantially cylindrical-shaped head 14 wherein the free ends of the bristles 17 form a substantially circular scrubbing surface 16, the scrubbing panel 22 is formed from a substantially circular panel 38 of fabric, as shown, for example, in FIG. 3. As indicated above, it is within the scope of the disclosure for non-illustrated embodiments of brush head cover 20 which are intended for use with foaming brushes having differently configured heads which result in differently shaped scrubbing surfaces to be formed from differently shaped scrubbing panels. For example, if a cover 20 is intended to be used with a brush head 14 having a substantially rectangular scrubbing surface 16, scrubbing panel 38 would be substantially rectangular.

The material from which continuous scrubbing panel 38 is fabricated is preferably a flexible, water-permeable material having at least one surface that that has a texture that is not likely to damage the finish of a painted object. In one embodiment of foaming brush head cover 20, panel 38 is fabricated from twelve ounce terry cloth fabric. It is within the scope of the disclosure for heavier or lighter weight terry cloth material to be used to fabricate scrubbing panel 38. Additionally, it is with the scope of the disclosure for the scrubbing panel 38 to be fabricated with other fabrics such as lamb's wool, microfiber, chenille, and/or wooltex or for the panel 38 to be fabricated from disposable material, such as “Stitch” material. Additionally, while scrubbing panel 38 is illustrated as being formed from a single piece of material, it is within the scope of the disclosure for the scrubbing panel 38 to be formed from one or more panels joined together in a manner that will not adversely affect the finish of an item being washed or from multiple layers of material. When fabricated from multiple panels or layers, it is within the scope of the disclosure for dissimilar materials to be used to fabricate the panel 38. In order to reduce the possibility of damage to the vehicle's surface and to maintain scrubbing surface in close contact with the vehicle surface being cleaned, scrubbing panel 38 is formed from a continuous sheet of material without the creation of slots or holes therein with edges that may fray and degrade the integrity of the scrubbing surface or abrade or mar the vehicle's surface.

One embodiment of brush cover 20 is configured for use with a foaming brush 12 having a head 14 with an approximately five inch diameter 39 comprised of five inch bristles defining a scrubbing surface 16 (referred to herein as a five inch diameter brush head or scrubbing surface). Thus, the illustrated scrubbing panel 38 of cover 20 is substantially circular and has a diameter 40 greater than the diameter 39 of the scrubbing surface 16 of the brush head 14 with which it is intended to be used. The diameter 40 of the scrubbing panel 38 is greater than the diameter 39 of the scrubbing surface 16 of the brush head 14 for at least two reasons. First, the scrubbing panel 38 must be joined to the first panel 32 of side wall 24 which joining operation will result in the diameter 42 of the scrubbing surface 44 of the brush cover 20 being smaller than the diameter 40 of the scrubbing panel 38. In the illustrated embodiment the scrubbing panel 38 is sewed to the side panel 32 forming a seam 46. Illustratively the seam 46 is a one quarter inch seam requiring that more than a quarter inch of material radially inward from the peripheral edge 48 of the scrubbing panel 38 being utilized to form the seam 46 by folding the material adjacent the peripheral edge 48 of the scrubbing panel 38 so as to interlock with a folded bottom edge 50 of the first side panel 32. Second, the diameter 40 of the scrubbing panel 38 is larger than the diameter 39 of the scrubbing surface 16 of the brush 12 to allow the brush head 14 to be inserted into the cavity 28 with the handle 19 extending through the opening 26 and to accommodate the increase in diameter of the scrubbing surface 16 of the brush head 14 when pressure is applied to the foaming brush 12 causing the bristles 17 to deform.

In one presently preferred embodiment wherein the brush head cover 20 that is configured for utilization with a foaming brush 12 having a five inch diameter scrubbing surface 16, the diameter 40 of the scrubbing panel 38 is approximately seven inches. This difference in diameter between the scrubbing surface 16 of the brush 12 and the scrubbing panel 38 allows the brush to be received in the cavity 28 of the cover 20 even after a portion of the scrubbing panel 38 is utilized to form the seam 46 joining the scrubbing panel 38 to the first side panel 32. When the brush head 14 is received in the cavity 28, the scrubbing panel 38 is positioned to be disposed between the scrubbing surface 16 of the brush 12 and the item being washed. Thus the scrubbing panel 38 prevents the scrubbing surface 16 of the brush 12 and any contaminants thereon from contacting the surface of the item being washed.

In one presently preferred embodiment of cover 20, the first side panel 32 is formed from a rectangular panel of flexible, water permeable material having at least one surface that has a texture that is not likely to damage the finish of a painted object. In one embodiment of foaming brush head cover 20, panel 32 is fabricated from twelve ounce terry cloth fabric. It is within the scope of the disclosure for heavier or lighter weight terry cloth material to be used to fabricate first side panel 32. Additionally, it is with the scope of the disclosure for the first side panel 32 to be fabricated with other fabrics such as lamb's wool, microfiber, chenille, and/or wooltex or for the panel 32 to be fabricated from disposable material, such as “Stitch” material. Additionally, while the first side panel 32 is illustrated as being formed from a single piece of material, it is within the scope of the disclosure for the first side panel 32 to be formed from one or more panels joined together in a manner that will not adversely affect the finish of an item being washed or from multiple layers of material. When fabricated from multiple panels or layers, it is within the scope of the disclosure for dissimilar materials to be used to fabricate the panel 32. Preferably, panel 32 is fabricated from the same material as panel 38 in the event that there is some incidental contact between the bottom portion of first side panel 32 and the surface of the item being washed.

As shown, for example, in FIGS. 1, 2 and 6-8 and more particularly in FIG. 4, first side panel 32 is formed from a rectangular panel of material having a bottom edge 50, a top edge 52, a first end edge 54, a second end edge 56, an outside surface 58 and an inside surface (not visible in the drawings.) The first panel 32 has a length 60 and a width 62. Illustratively, the length 60 of first panel 32 is approximately equal to the circumference of the scrubbing panel 38 to facilitate forming seams at each end of the panel 32 and joining the first side panel 32 to the scrubbing panel 38 while leaving a gap between opposite seamed ends of the first side panel 32 in the fully assembled brush head cover 20. The illustrated embodiment of first side panel 32 has a width 62 that is sufficient to allow a plurality of holes 64 to be formed in the side panel 32 in a position in which the holes 64 do not interfere with the formation of the seam 46 joining the bottom edge 50 of the first side panel 32 to the scrubbing panel 38 and a seam 66 joining the top edge 52 of the first side panel 32 to a bottom edge 78 of the second side panel 34. In the embodiment of cover 20 intended for use with a brush 12 having a five inch diameter scrubbing surface 16, the length 60 of side panel 32 is approximately twenty-two inches and the width 62 of the first side panel 32 is approximately two and a half inches. The length 60 of first side panel 32 allows a seam 68 to be formed by folding the first end edge 54 over onto the outside surface 58 of the first side panel 32 and a seam 70 to be formed by folding the second side edge 56 over onto the outside surface 58 of the first panel 32. In the illustrated embodiment seams 68 and 70 are both one inch seams.

In the illustrated embodiment, the plurality of holes 64 include ten equally longitudinally spaced holes centered between the top edge 52 and the bottom edge 50. Each hole 64 has a diameter 72 that is less than the width 62 of the first side panel 32. In the illustrated embodiment, the diameter 72 of each hole 64 is one half inch. Each hole 64 is displaced from its adjacent holes 64 by a displacement 74. The end holes 64 are displaced from the adjacent edge 54, 56 by a displacement 76. In the embodiment of brush head cover 20 configured for use with a five inch diameter brush 12, the displacement 74 between adjacent holes 64 is one and a half inches while the displacement 76 between the end holes 64 and their adjacent edge 54, 56 is one and three quarters inches.

The holes 64 in first side panel 32 are sized to allow foam (formed, for example, by combining water from a source of water 9 (FIG. 6) with soap or detergent from a source of soap or detergent 11 and aerating the mixture with compressed air from a source of compressed air 13) to escape from the head 14 of a foaming brush 12 received in the cavity 26 of the brush head cover 20 to the exterior of the cover 20. Foam escaping through holes 64 is disposed on the outside surface of the side wall 24 adjacent the surface of an item being washed. During utilization of a covered foaming brush combination 100, foam may discharge through the holes 64 onto the item being washed. While ten equally spaced holes 64 are shown in the drawings, it is within the scope of the disclosure for the holes 64 to not be equally spaced or for more or fewer holes 64 to be formed in the first side panel 32. In this manner, holes 64 also provide for release of pressure from inside cover 20 when attached to brush 12 and permit discharge of various viscosities of soap 11 and other car wash cleaning fluids (or rinsing water) from brush 12 onto the vehicle surface while also permitting scrubbing surface 38 to remain in frictional contact with the vehicle surface being cleaned.

In the illustrated embodiment of cover 20, the second side panel 34 is formed from a rectangular panel of flexible, water permeable material. In one embodiment of foaming brush head cover 20, panel 34 is fabricated from mesh material having a large plurality of openings 77 through which foam escaping from the head 14 of a foaming brush 12 captured in the cavity 28 of the brush head cover 20 discharges. In the illustrated embodiment, the second side panel 34 is formed from multi-filament polyester mesh knit. In one specific embodiment the second side panel 34 is formed from multi-filament polyester mesh knit having one sixteenth inch openings 77 with 13×11 openings 77 per square inch. It is within the scope of the disclosure for other mesh knit material having more or fewer openings 77 per square inch and/or larger or smaller openings 77 to be used to fabricate second side panel 34. Additionally, it is with the scope of the disclosure for the second side panel 34 to be fabricated with other mesh fabrics such as cheese cloth or from fabrics similar to those utilized to fabricate the scrubbing panel 38 and/or the first side panel 32. Additionally, while the second side panel 34 is illustrated as being formed from a single piece of material, it is within the scope of the disclosure for the second side panel 34 to be formed from one or more panels joined together or from multiple layers of material. While it is not intended that the second side panel 34 engage the surface of the item being washed it is within the scope of the disclosure for the second side panel 34 to be fabricated from material having an outside surface that will not adversely affect the finish of an item being washed. When fabricated from multiple panels or layers, it is within the scope of the disclosure for dissimilar materials to be used to fabricate the panel 34. Second panel 34 further provides for discharge of foaming soap (or rinsing water) from brush 12 while reducing pressure within cover 12 and assisting in maintaining scrubbing surface 38 in contact with the vehicle surface being cleaned.

Foaming brushes 12 occasionally discharge foam at a rate that the foam may shoot from the head 14 of the brush 12 and be deposited on items that it was not intended to be deposited upon, such as, for example, the clothes of the user or others in the wash bay, other items in the wash bay or the wash bay itself. The mesh material from which second side panel 34 is foamed as well as the holes 64 formed in the first side panel 32 allow foam to continue to be discharged from the combination brush and cover 100, while reducing unwanted scatter of foam throughout the wash bay.

As shown, for example, in FIGS. 1, 2 and 6-8 and more particularly in FIG. 5, second side panel 34 is formed from a rectangular panel of material having a bottom edge 78, a top edge 80, a first end edge 82 and a second end edge 84. The second side panel 34 has a length 86 and a width 88. Illustratively, the length 86 of second panel 34 is approximately equal to the circumference of the scrubbing panel 38 to facilitate forming seams 68, 70 at each end of the panel 34 while leaving a gap between opposite seamed ends of the first side panel 32 in the assembled brush head cover 20. Likewise, length 86 of second side panel 34 is approximately equal to length 60 of first side panel 32 to facilitate joining the first side panel 32 to the second side panel at seam 66. The illustrated embodiment of second side panel 34 has a width 88 that is sufficient to allow the formation of the seam 66 joining the top edge 52 of the first side panel 32 to the bottom edge 78 of the second side panel 34 and to form seam 90 by folding the top edge 80 over onto the inside surface of second panel 34 to form a channel for receipt of a cord 96 of the closure device 30. In the illustrated embodiment the seam 90 is approximately two inches wide. In the embodiment of cover 20 intended for use with a brush 12 having a five inch diameter scrubbing surface 16, the length 86 of side panel 34 is approximately twenty-two inches and the width 88 of the second side panel 34 is approximately six inches. The length 86 of second side panel 34 allows a seam 68 to be formed by folding the first end edge 82 over onto the outside surface of the second side panel 34 and a seam 70 to be formed by folding the second side edge 84 over onto the outside surface of the second panel 34. In the illustrated embodiment seams 68 and 70 are both one inch seams.

The overall length 94 of side wall 24 of cover 20 is preferably greater than the combined distance 92 of the thickness of the bristle support 15 and the exposed length of the bristles 17 of foaming brush head 14. The overall length 94 of side wall 24 should be such that when the closure device 30 is used to close the top opening 26 after the brush head 14 is received in the cavity 28, the cover 20 is secured to the head 14 of the foaming brush 12 with the handle 19 extending through the cinched opening.

In the illustrated embodiment, the closure device 30 includes a cord 96 and a cord lock 98. The cord 96 has a length sufficient to extend through the channel formed by the top seam 90 with both free ends of the cord extending a sufficient distance from the edges of the gap 36 to allow the cord lock 98 to be received on both ends of the cord 96 when the top opening 26 is completely open.

In one preferred embodiment, the cord 96 has a length of approximately thirty inches. While cord 96 can be formed from various materials, the illustrated cord 96 is formed from one thousand pound spun polyester draw tape having a width of five-eighths inches. Thus cord 96 easily fits within and slides freely within the channel formed by the top seam 90.

The illustrated cord closure device 30 forms a drawstring closure for cinching the top opening 26 closed when the head 14 of the foaming brush 12 is received in the cavity 28. Preferably, the overall length 94 of the side wall 24 is such that when the closure device 30 cinches the top opening 26 closed, the material adjacent the top opening is pulled across the top surface of the bristle support 15 and forms an opening large enough for the handle 19 to extend therethrough. The plastic cord lock 98 eases the tightening and loosening of the drawstring closure. While other closure devices, including drawstrings without cord locks, may be utilized within the scope of the disclosure, the cord lock 98 helps to avoid tight knots being formed in the cord 96 which might be difficult to untie with wet soapy hands in a car wash. In addition, the use of cord lock and drawstrings has been found advantageous in that the customer can generally fit cover 20 over brush 12 while handle assembly 19 is in its storage rack position along the car wash bay and avoid contact with the potentially contaminated brushes and unwanted contact with person or clothes and water or other car wash fluids.

Advantageously the disclosed cover 20 for a head 14 of a foaming brush 12 when utilized with a foaming brush 12 to form a combination 100 (FIGS. 7 and 8) to wash a vehicle protects the vehicle from any contaminated foreign matter left on the brush head 14 from a prior car wash user. The disclosed cover 20, with its solid scrubbing panel 38, places the scrubbing surface 44 of the cover 20 between the scrubbing surface 16 of the brush 12 and the item being washed to prohibit any portion of the brush head's scrubbing surface 16 from contacting the item being washed while the cover 20 is properly attached to the brush head 14. Additionally, the disclosed cover 20 for a head 14 of a foaming brush 12 when utilized with a foaming brush 12 to form a combination 100 for washing a vehicle advantageously provides a protective cover for the foaming brush head at a car wash facility.

According to one presently preferred embodiment, the scrubbing panel 22 of cover 20 comprises terry cloth material. To the extent that the terry cloth material has one surface with more piling than the other surface, those components of the cover 20 formed from the terry cloth material will preferably utilize the surface with more piling as the outside surface of the component. The scrubbing panel 22 is attached to a two component side wall 24 comprised of a terry cloth panel 32 with at least one hole 64 formed therethrough. The side wall 24 includes a mesh netting panel 34 joined to the terry cloth panel 32. The one or more holes 64 in the terry cloth panel 32 and the plurality of openings 77 in the mesh netting panel 34 allow the thick high lubricity or viscosity brush soap to spill out of the brush head cover 20 onto the surface of the item being washed. The illustrated brush head cover 20 can fit over a round brush head 14 like a shower cap. The cord 96 is slidably received in a channel formed by a seam 90 adjacent the top opening 26 of the cover 20. The drawstring or closer 96 is pulled tight and is held onto the brush head 14 by a small plastic fastener 98. Thus, the disclosed cover 20 is configured to be easily applied to and removed from a brush head 14.

When a head cover 20 has been utilized with a foaming brush 12 in a car wash 10 to wash an item, the cover 20 may be rinsed out using the spot free cycle of the self serve wash options prior to removing the cover 20 from the brush head 14. When the customer is finished washing their car, they should rinse and remove the cover 20 from the brush head 14 for disposal or storage for reuse in the future. The customer should wring the spot free water out of the cover 20 after rinsing and may then place the cover 20 in a storage bag for storage in a convenient location such as in their vehicle trunk or storage compartment.

The disclosed cover 20 should be re-usable numerous times depending on the level of use and care it receives. This provides an affordable and readily available device for protection of the vehicle from paint or other damage that can easily be created by a contaminated brush head.

Although the present disclosure has been described and illustrated with respect to a preferred embodiment and a preferred use therefore, it is not to be so limited since modifications and changes can be made therein which are within the full intended scope of the disclosure.

What is claimed is:

1. A cover for a foaming brush having a head including a scrubbing member and a scrubbing support configured to allow foam to pass through the scrubbing member to a scrubbing surface of the brush having a footprint, the cover comprising:
a flexible scrubbing panel configured to conform generally to the footprint of the scrubbing surface of the foaming brush, the scrubbing panel being formed from a continuous sheet of material and including an outwardly disposed surface having a texture that should not adversely affect a finished surface of an item being washed;
a flexible side wall contiguously joined at a bottom edge to a substantial portion of a peripheral edge of the scrubbing panel and cooperating with the scrubbing panel to define a substantial enclosure closed on the bottom by the scrubbing panel, substantially closed on the side by the side wall and including a top opening, the flexible side wall being configured to define at least one foam discharge hole through which foam from a foaming brush having its head disposed in an interior of the enclosure discharges to an exterior of the enclosure; and
a closure device coupled to the side wall adjacent the top opening and configured to at least partially close the top opening when a head of a foaming brush is received in the interior of the enclosure.

2. The cover of paragraph 1 wherein the side wall includes a bottom panel joined at its bottom edge to a substantial portion of the peripheral edge of the scrubbing panel, wherein the bottom panel is formed from a flexible solid material and is formed to include a discharge hole extending between the interior of the enclosure and the exterior of the enclosure.

3. The cover of paragraph 2 wherein the bottom panel is fabricated from the same type of material as the scrubbing panel.

4. The cover of paragraph 2 wherein the bottom panel is formed to include a plurality of foam discharge holes.

5. The cover of paragraph 2 wherein the side wall includes a flexible top panel joined at its bottom edge to a top edge of the bottom panel and formed from a type of material different than the type of material from which the bottom panel is formed.

6. The cover of paragraph 5 wherein the top panel is formed from a material having a plurality of foam discharge holes formed therein.

7. The device of paragraph 6 wherein the bottom panel is formed from a material selected from the group of terry cloth, lamb's wool, microfiber, chenille, wooltex and a disposable material.

8. The device of paragraph 6 wherein the scrubbing panel and the bottom panel are formed from terry cloth material.

9. The device of paragraph 8 wherein the top panel is formed from a mesh material.

10. The device of paragraph 9 wherein the top panel is formed to include a channel adjacent the top opening through which a cord of the closure device passes to form a drawstring type closure device.

11. The cover of paragraph 5 wherein the side wall extends a distance from the scrubbing panel to the top opening, the distance being greater than a combined thickness of the scrubbing member and scrubbing member support of the head of the foaming brush.

12. A cover for the head of a foam brush of the type that expels foam from the head thereof, the cover comprising:
a bag having a continuous scrubbing surface and a side wall joined together to form an interior cavity; the bag having a mouth for allowing ingress into the interior cavity; the bag having a plurality of foam discharge holes in side wall thereof for allowing foam to pass therethrough; and
a closure device configured to close the mouth of the bag when the head of a brush is received in the interior of the cavity and to secure the bag to the head of the brush.

13. The cover of paragraph 12 wherein the scrubbing surface is formed from a solid panel of flexible water-permeable material.

14. The cover of paragraph 13 wherein the scrubbing surface is formed from terry cloth.

15. The cover of paragraph 13 wherein the side wall includes a top portion adjacent the mouth, the top portion being formed from a flexible mesh material including a plurality of holes formed therein for allowing foam to pass therethrough.

16. The cover of paragraph 15 wherein the side wall includes a bottom portion adjacent the scrubbing surface, the bottom portion being formed from the same type of material as the scrubbing surface and being formed to include at least one hole therein for allowing foam to pass therethrough.

17. The cover of paragraph 16 wherein the closure device includes a cord and the top portion and the cord cooperate to form a drawstring closure for the mouth.

18. In combination:
a foam brush comprising:
a head including a scrubbing member having a scrubbing surface and a support for the scrubbing member;
a handle coupled to the head; and
wherein the head is coupled through the handle to a soap/water source and configured to allow a soap/water mixture to expel foam from the scrubbing member; and
a cover covering the head of the foam brush; the cover comprising:
a bag having a continuous scrubbing surface and a side wall joined together to form an interior cavity holding the head of the foam brush with the scrubbing surface of the bag disposed adjacent the scrubbing surface of the brush to prevent any portion of the scrubbing surface of the brush from contacting an item being washed with the combination; the bag having a mouth through which the handle of the foam brush extends from the support of the head; the bag having a plurality of holes in the side wall thereof allowing foam from the head of the foam brush to pass therethrough, the bag being formed to include a channel adjacent the mouth; and
a cord extending through the channel adjacent the mouth of the bag and cooperating with the channel to form a drawstring type closure which upon pulling the cord draws the bag around the head of the foam brush and secures the bag to the head of the foam brush.

19. The combination of paragraph 18 wherein the side wall includes a portion adjacent the scrubbing surface formed from the same material as the scrubbing surface and formed to include a hole therein allowing foam from the head of the brush to pass therethrough.

20. The combination of paragraph 19 wherein the side wall includes a mesh portion adjacent the mouth formed to include a plurality of holes allowing foam from the head of the brush top pass therethrough.
